(19) United States
(12) Patent Application Publication
(10) Pub. No.: US 2011/0103663 A1
(43) Pub. Date: May 5, 2011

(54) APPARATUS, METHOD AND COMPUTER-READABLE STORAGE MEDIUMS FOR DETECTING A REGION OF INTEREST IN A MEDICAL IMAGE

(75) Inventors: Wilfred Rosenbaum, Coqutilam (CA); Cristian Bonciu, Burnaby (CA)

(73) Assignee: McKesson Financial Holdings Limited

(21) Appl. No.: 12/611,594

(22) Filed: Nov. 3, 2009

(51) Int. Cl. G06K 9/00

(52) U.S. Cl. 382/131

(57) ABSTRACT

A method is provided that includes receiving a digital image, and detecting a region of interest of the digital image. Detecting a region of interest includes thresholding the digital image to create a corresponding binary image, and identifying one or more connected components in the binary image. The binary image includes a plurality of pixels each of which is one of only two possible colors, and each of the connected component(s) comprising a set of pixels of the first color such that any two pixels in the set are joined by a continuous path of pixels of the first color. Detecting a region of interest also includes identifying a largest connected component from the connected component(s), and determining, as the region of interest of the digital image, coordinates of an area of the digital image defining a smallest predetermined shape that contains the largest connected component.

### FIELD OF THE INVENTION

The present invention generally relates to medical imaging, and more particularly, to detecting a region of interest (ROI) in a medical image, such as detecting breast tissue in a mammography image.

### BACKGROUND OF THE INVENTION

Medical imaging often includes creating images of the human body or parts of the human body for clinical purposes such as examination, diagnosis and/or treatment. When viewing medical images on a diagnostic radiology workstation, many radiologists prefer to display each image so that it is magnified as much as possible while still showing all of a region of interest (ROI) of the image within the display viewport. More particularly in the context of mammography images, for example, many radiologists prefer to display each image so that it is magnified as much as possible while still showing all of the breast anatomy within the display viewport. To do this manually may require considerable interactive image zooming and panning be performed by the radiologist—interactive operations that would be disagreeable and disruptive to the workflow of most radiologists. However, such zooming and panning may be viewed as tedious and a serious impediment to productive workflow.

### SUMMARY OF THE INVENTION

In light of the foregoing background, exemplary embodiments of the present invention provide an apparatus, method and computer-readable storage medium for detecting a region of interest (ROI) in a medical image. More particularly, for example, embodiments of the present invention provide a configurable software algorithm that accepts a digital mammography image as input and returns the coordinates of a shape (e.g., rectangle as output), where the rectangle identifies the region within the input mammography image that contains breast tissue. In this regard, exemplary embodiments of the present invention may be particularly described herein in the context of detecting breast tissue in a digital mammography image. It should be understood, however, that exemplary embodiments of the present invention may be applicable to detecting any of a number of other areas of interest within digital mammography images or within other medical images.

According to one aspect of exemplary embodiments of the present invention, an apparatus is provided that includes a processor and a memory storing executable instructions that in response to execution by the processor cause the apparatus to at least perform a number of functions or steps. These functions or steps include receiving a digital image (e.g., digital mammography image), and detecting a region of interest of the digital image. Detecting a region of interest includes thresholding the digital image to create a corresponding binary image, and identifying one or more connected components in the binary image. In this regard, the binary image includes a plurality of pixels each of which is one of only two possible colors (the two possible colors being a first color and a second color), and each of the connected component(s) comprising a set of pixels of the first color such that any two pixels in the set are joined by a continuous path of pixels of the first color.

Detecting a region of interest also includes identifying a largest connected component from the identified connected component(s), and determining coordinates of an area of the digital image defining a smallest predetermined shape (e.g., rectangle) that contains the largest connected component. This area of the digital image may then be designated as a region of interest of the digital image.

In various instances, detecting a region of interest may further include shrinking the digital image. In such instances, thresholding the digital image may include thresholding the shrunken digital image. And determining coordinates of an area of the digital image may include determining coordinates of an area of the shrunken digital image, and determining corresponding coordinates of the digital image from the coordinates of the area of the shrunken image and dimensions of the digital image.

The memory of the apparatus may store additional executable instructions that cause the apparatus to further perform a number of other functions or steps. These functions or steps may include determining or receiving one or more parameters, one or more of which may be based on one or more attributes of the digital image. The parameters may include a method for determining a threshold, a shrinkage factor representing an amount of shrinkage of the image and/or a selected level of connectedness.

When the parameters include a method for determining a threshold, determining the parameter may include selecting a method for determining a threshold from a plurality of different methods for determining a threshold. Thresholding the digital image may then include determining a threshold according to the selected method for determining a threshold, and thresholding the digital image based on the determined threshold. In this regard, the selected method for determining a threshold may be variable based on one or more attributes of the digital image.

When the parameters include a shrinkage factor and in instances in which the functions or steps include shrinking the digital image, shrinking the digital image may include shrinking the digital image based on the shrinkage factor. And when the parameters include a selected level of connectedness, identifying one or more connected components may include identifying one or more connected components according to the selected level of connectedness.

As indicated above and explained below, exemplary embodiments of the present invention may solve problems identified by prior techniques and provide additional advantages. For example, embodiments of the present invention may allow a radiology workstation to automatically display a mammography image zoomed and panned so that the breast anatomy fills the viewport without the need for additional manual interactive operations.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a system configured to operate in accordance with exemplary embodiments of the present invention;

FIG. 2 is a schematic block diagram of a computing apparatus, in accordance with embodiments of the present invention; and

FIG. 3 is a control flow diagram of software subsystems of a computing apparatus configured to operate in accordance with exemplary embodiments of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. For example, references may be made herein to colors including black and white; it should be understood, however, that any color references are simply examples and that any particular colors may depend on the particular image or processing of the particular image with which the color reference is made. Like numbers refer to like elements throughout.

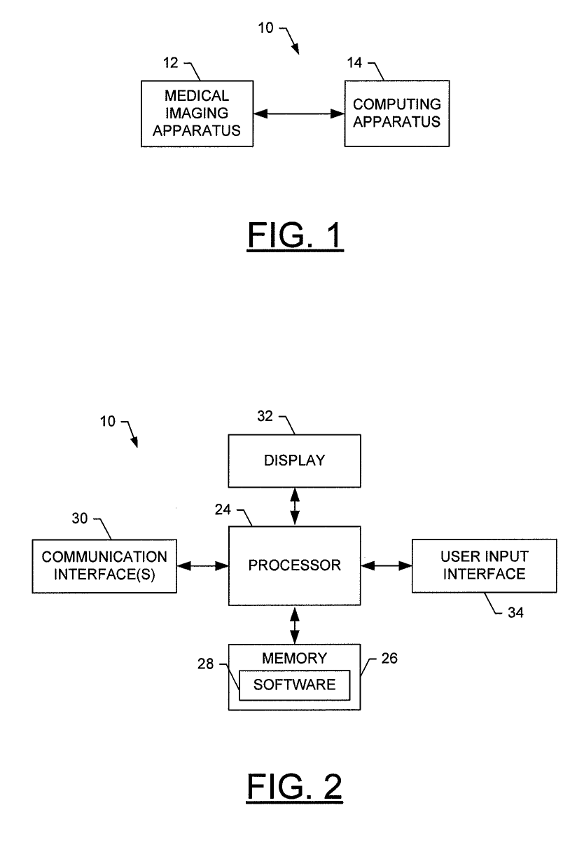

Referring to FIG. 1, a system 10 for detecting a region of interest (ROI) in a medical image includes a medical imaging apparatus 12 and a computing apparatus 14. The medical imaging and computing apparatuses can comprise any one or more of a number of different apparatuses, devices or the like configured to operate in accordance with embodiments of the present invention. The medical imaging apparatus can comprise any of a number of apparatuses configured to produce a medical image, such as in accordance with any of a number of medical imaging techniques. One example medical imaging apparatus is an x-ray machine configured to produce mammography images of the human breast.

The computing apparatus 14 can comprise, include or be embodied in one or more processing elements, such as one or more of a laptop computer, desktop computer, server computer or the like. In various instances, the computing apparatus may form a diagnostic radiology workstation. It should also be understood that although shown as separate entities, in some exemplary embodiments, a single apparatus may support both the medical imaging apparatus 12 and the computing apparatus, logically separated but co-located within the single apparatus.

The medical imaging apparatus 12 is configured to directly and/or indirectly communicate with the computing apparatus 14. The medical imaging apparatus and the computing apparatus can be configured to communicate with one another in accordance with any of a number of wireline or wireless communication or networking techniques. Examples of such techniques include, without limitation, Universal Serial Bus (USB), radio frequency (RF), Bluetooth (BT), infrared (IrDA), any of a number of different cellular (wireless) communication techniques such as any of a number of 2G, 2.5G or 3G communication techniques, local area network (LAN), wireless LAN (WLAN) techniques or the like. In accordance with various ones of these techniques, the medical imaging and computing apparatuses can be coupled to and configured to communicate across one or more networks. The network(s) can comprise any of a number of different combinations of one or more different types of networks, including data and/or voice networks. For example, the network(s) can include one or more data networks, such as a LAN, a metropolitan area network (MAN), and/or a wide area network (WAN) (e.g., Internet), and include one or more voice networks, such as a public-switched telephone network (PSTN). Although not shown, the network(s) may include one or more apparatuses such as one or more routers, switches or the like for relaying data, information or the like between the medical imaging and computing apparatuses.

Referring now to FIG. 2, a block diagram of a computing apparatus 14 is shown in accordance with exemplary embodiments of the present invention. As shown, the computing apparatus includes various means for performing one or more functions in accordance with exemplary embodiments of the present invention, including those more particularly shown and described herein. It should be understood, however, that the computing apparatus may include alternative means for performing one or more like functions, without departing from the spirit and scope of the present invention. More particularly, for example, as shown in FIG. 2, the computing apparatus may include a processor 24 connected to a memory 26. The memory can comprise volatile and/or non-volatile memory, and typically stores content, data or the like. In this regard, the memory may store one or more software applications 28, modules, instructions or the like for the processor to perform steps associated with operation of the computing apparatus in accordance with embodiments of the present invention. The memory may also store content transmitted from, and/or received by, the computing apparatus. As described herein, the software application(s) may each comprise software operated by the computing apparatus. It should be understood, however, that any one or more of the software applications described herein may alternatively be implemented by firmware, hardware or any combination of software, firmware and/or hardware, without departing from the spirit and scope of the present invention.

In addition to the memory 26, the processor 24 can also be connected to at least one interface or other means for displaying, transmitting and/or receiving data, content or the like, such as in accordance with USB, RF, BT, IrDA, WLAN, LAN, MAN, WAN (e.g., Internet), PSTN techniques or the like. In this regard, the interface(s) can include at least one communication interface 30 or other means for transmitting and/or receiving data, content or the like. In addition to the communication interface(s), the interface(s) can also include at least one user interface that can include one or more earphones and/or speakers (e.g., speaker 20), a display 32, and/or a user input interface 34. The user input interface, in turn, can comprise any of a number of devices allowing the apparatus to receive data from a user, such as a microphone (e.g., microphone 22), a keypad, a touch-sensitive surface (integral or separate from a display 32), a joystick, or other input device.

Exemplary embodiments of the present invention provide an apparatus, method and computer-readable storage medium for detecting a region of interest (ROI) in a medical image. More particularly, for example, embodiments of the present invention provide a configurable software algorithm that accepts a digital mammography image as input and returns the coordinates of a rectangle as output, where the rectangle identifies the region within the input mammography image that contains breast tissue. As indicated above, exemplary embodiments of the present invention may be particularly described herein in the context of detecting breast tissue in a digital mammography image. It should be understood, however, that exemplary embodiments of the present invention may be applicable to detecting any of a number of other areas of interest within digital mammography images or within other medical images.

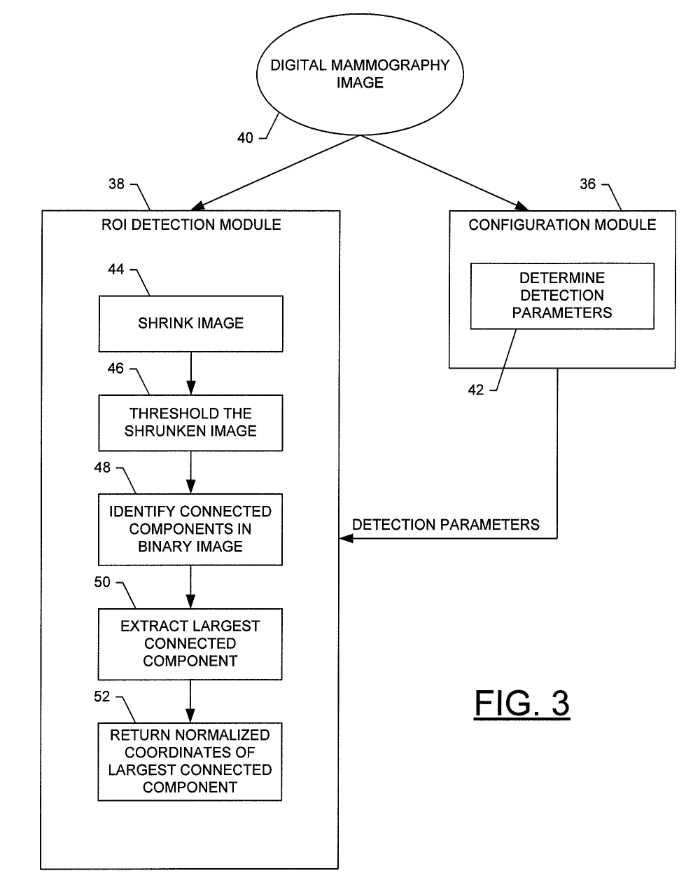

Reference is now made to FIG. 3, which illustrates a control flow diagram of software modules of the apparatus 10 of exemplary embodiments of the present invention. As indicated above, the software modules may be stored in memory 26 of the apparatus and include executable instructions that in response to execution by the processor 24 of the apparatus cause the apparatus to at least perform functions to carry out a method of detecting a ROI in a medical image. Although described as software modules, it should be understood that various functions performed by the software modules may instead be performed by hardware and/or firmware of the apparatus of exemplary embodiments of the present invention. It should also be understood that although shown as separate modules, the modules may instead be implemented by a single module.

As shown in FIG. 3, in accordance with exemplary embodiments of the present invention, the apparatus 10 may include a configuration module 36 and a ROI detection module 38. The modules may be configured to receive a digital mammography image or attributes from a digital mammography image 40, such as from the medical imaging apparatus 12. More particularly, for example, the configuration module may be configured to receive attributes from the image and determine, from the attributes, one or more parameters from which the ROI detection module may be configured to detect a ROI in the image, as shown in block 42. As an alternative to determining one or more parameters, the configuration module may instead be configured to receive one or more parameters, such as from a user of the apparatus or from the image itself. In this regard, the parameters may be determined, received or otherwise selected as a function of the image (or the medical imaging apparatus 12 that produced the image), but may additionally or alternatively be determined, received or otherwise selected as a function of a desired speed or precision of the ROI detection.

In one instance in which the image is formatted in accordance with the Digital Imaging and Communications in Medicine (DICOM) Standard, the configuration module 36 may be configured to receive DICOM header attributes from the image and determine one or more parameters from the attributes. Examples of DICOM attributes that may be usable for determining one or more parameters include “Acquisition Device Processing Description” (indicating any device-specific processing associated with the image), “Conversion Type” (indicating a kind of image conversion), “Bits Stored” (indicating the number of bits stored per pixel sample) and “Pixel Representation” (indicating the data representation of the pixel samples—e.g., unsigned integer). A list of other DICOM attributes that may be usable for determining one or more parameters is provided in Part 3 of the National Electrical Manufacturers Association (NEMA) DICOM Standard (Information Object Definitions).

The parameters determined or otherwise received by the configuration module 36 may include, for example, a factor or other value representing an amount of shrinkage of the image, which may be represented by a shrinkage factor of 2″ in both the horizontal and vertical directions (n being a positive integer also representing the amount of shrinkage). The parameters may also include selection of a method (or algorithm) for determining a threshold usable for thresholding the digital mammography image 40 to create a corresponding binary image. Further, for example, the parameters may include selection of a level of “connectedness” or “connectivity” (e.g., 4-connected, 8-connected, etc.) to be used in identification of connected components of the binary image.

The aforementioned methods that may be used to determine a threshold include an absolute threshold, or a relative threshold that may, for example, be based on a specified cut point of the image histogram representation of the mammography image. Alternatively, the threshold may be determined according to a local minimum threshold method by determining the local minimum following a global maximum value in a (smoothed) image histogram representation of the digital mammography image 40. As another example, the threshold may be determined according to a linear discriminant threshold method such as Otsu's method whereby the threshold is chosen to maximize the variance between the putative black background and white foreground in the digital mammography image. And as yet another example, the threshold may be determined according to a mid-range threshold method whereby the threshold is determined as the middle of the pixel range defined by the digital mammography image's “Bits Stored” and “Pixel Representation” DICOM attributes.

Each of the parameters determined or otherwise received by the configuration module 36 may be varied independently (via configuration) for arbitrary classes of images. This may allow the runtime behavior of a single implementation to be adaptable to image characteristics that are not known in advance. Regardless of the parameters or their manner of being determined or otherwise received, the parameters may be supplied to the ROI detection module 38, which may also receive the digital mammography image 40 and detect a ROI in the image based on the parameters.

In various instances, the configuration module 36 may determine or receive the parameters according to a number of rules. In one particular example in which the image is formatted in accordance with the DICOM Standard, default parameters and their values may include a shrinkage factor of 16 (2⁴), selection of the relative threshold method with a threshold parameter of 0.01, and selection of a connectivity of 8-connected. When the DICOM header of an image includes the “Acquisition Device Processing Description” attribute with a value of “Premium_View” (reflecting the application of a General Electric proprietary mammography image enhancement technique), the configuration module may alter the default parameters to include the local minimum threshold method instead of the default relative threshold method. And when the DICOM header includes the “Conversion Type” attribute with a value “WSD” (reflecting a workstation converted image), the configuration module may alter the default parameters to include the linear discriminant threshold method (e.g., Otsu's method) instead of the default relative threshold method.

As shown, the method by which the ROI detection module 38 determines the ROI may include shrinking the digital mammography image 40, such as in a manner based on the aforementioned shrinkage factor or other value determined or received by the configuration module 36, as shown in block 44. As or after the image is shrunk, the ROI detection module 38 may determine a threshold value according to the selected method for determining the threshold (as part of the parameters received from the configuration module 36), as shown in block 46. As indicated above, these methods may include an absolute threshold, relative threshold, local minimum threshold method linear discriminant threshold method or mid-range threshold method. Regardless of the exact method by which the threshold is determined, the threshold may be determined and applied by the ROI detection module to the shrunken image to create a binary image representation of the digital mammography image 40. In this regard, pixels in the shrunken image whose value is less than or equal to the threshold may be set to black in the binary image; or otherwise, pixels in the shrunken image whose value is greater than the threshold may be set to white in the binary image.

As shown in block 48, after creating the binary image representation of the digital mammography image 40, the ROI detection module 38 may identify connected components in the binary image. This may be accomplished according to the connectedness or connectivity selection from the parameters determined or otherwise received by the configuration module 36. According to graph theory, a connected component in this context may refer to a set of white pixels in the binary image such that any two pixels in the set may be joined by a continuous path of white pixels. Informally, a connected component may be considered a maximal connected subset of white pixels in the binary image. And the selected connectivity may represent the smallest number of white pixels that must be removed to disconnect it (such that no two pixels are joined by a continuous path of white pixels).

After identifying the connected components, the ROI detection module 38 may identify the largest connected component of the binary image, as shown in block 50. The ROI detection module may then determine the normalized coordinates of an area of the image (shrunken image) defining the smallest predetermined shape (e.g., rectangle) that contains the largest connected component in the binary image, as shown in block 52. The normalized coordinates of that area of the digital image may then be denormalized using the dimensions of the original digital mammography image 40 to thereby determine the corresponding coordinates of the original digital mammography image. The area of the image defined by the normalized or denormalized coordinates may be considered or otherwise designated as the ROI.

After the ROI is designated, the ROI may be displayed by the apparatus 10 and/or manipulated by a user of the apparatus, such as via additional viewer functionality of the ROI detection module 38 or a separate viewer software application operable by the apparatus. The ROI may be displayed in any of a number of different manners. For example, the ROI may be displayed within the original digital mammography image 40 by automatically panning and zooming within the image to the ROI. Alternatively, for example, the ROI may be displayed separate from the original digital mammography image, such as by cropping the original digital mammography image to the ROI. In any instance, by the apparatus automatically detecting the ROI, the user may readily view it without needing to manually zoom and pan within the digital mammography image.

According to one aspect of the present invention, all or a portion of the computing apparatus 14 of exemplary embodiments of the present invention, generally operate under control of a computer program. The computer program for performing the methods of exemplary embodiments of the present invention may include one or more computer-readable program code portions, such as a series of computer instructions, embodied or otherwise stored in a computer-readable storage medium, such as the non-volatile storage medium.

FIG. 3 is a control flow diagram reflecting methods, systems and computer programs according to exemplary embodiments of the present invention. It will be understood that each block or step of the control flow diagram, and combinations of blocks in the control flow diagram, may be implemented by various means, such as hardware, firmware, and/or software including one or more computer program instructions. As will be appreciated, any such computer program instructions may be loaded onto a computer or other programmable apparatus to produce a machine, such that the instructions which execute on the computer or other programmable apparatus (e.g., hardware) create means for implementing the functions specified in the block(s) or step(s) of the control flow diagram. These computer program instructions may also be stored in a computer-readable memory that may direct a computer or other programmable apparatus to function in a particular manner, such that the instructions stored in the computer-readable memory produce an article of manufacture including instruction means which implement the function specified in the block(s) or step(s) of the control flow diagram. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the block(s) or step(s) of the control flow diagram.

Accordingly, blocks or steps of the control flow diagram support combinations of means for performing the specified functions, combinations of steps for performing the specified functions and program instruction means for performing the specified functions. It will also be understood that one or more blocks or steps of the control flow diagram, and combinations of blocks or steps in the control flow diagram, may be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. It should therefore be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus comprising a processor and a memory storing executable instructions that in response to execution by the processor cause the apparatus to at least perform the following:
receiving a digital image; and
detecting a region of interest of the digital image, detecting a region of interest including:
thresholding the digital image to create a corresponding binary image, the binary image comprising a plurality of pixels each of which is one of only two possible colors, the two possible colors being a first color and a second color;
identifying one or more connected components in the binary image, each connected component comprising a set of pixels of the first color such that any two pixels in the set are joined by a continuous path of pixels of the first color;
identifying a largest connected component from the identified one or more connected components; and
determining coordinates of an area of the digital image defining a smallest predetermined shape that contains the largest connected component, the respective area of the digital image being designated as a region of interest of the digital image.

2. The apparatus of claim 1, wherein the memory stores executable instructions that in response to execution by the processor cause the apparatus to further perform the following:
determining or receiving one or more parameters based on one or more attributes of the digital image, including selecting a method for determining a threshold from a plurality of different methods for determining a threshold,
wherein thresholding the digital image comprises determining a threshold according to the selected method for determining a threshold, and thresholding the digital image based on the determined threshold.

3. The apparatus of claim 2, wherein the selected method for determining a threshold is variable based on one or more attributes of the digital image.

4. The apparatus of claim 1, wherein detecting a region of interest further comprises:
shrinking the digital image,
wherein thresholding the digital image comprising thresholding the shrunken digital image, and
wherein determining coordinates of an area of the digital image comprises determining coordinates of an area of the shrunken digital image, and determining corresponding coordinates of the digital image from the coordinates of the area of the shrunken image and dimensions of the digital image.

5. The apparatus of claim 4, wherein the memory stores executable instructions that in response to execution by the processor cause the apparatus to further perform the following:
determining or receiving one or more parameters including a shrinkage factor representing an amount of shrinkage of the image,
wherein shrinking the digital image comprises shrinking the digital image based on the shrinkage factor.

6. The apparatus of claim 1, wherein the memory stores executable instructions that in response to execution by the processor cause the apparatus to further perform the following:
determining or receiving one or more parameters including a selected level of connectedness,
wherein identifying one or more connected components comprises identifying one or more connected components according to the selected level of connectedness.

7. The apparatus of claim 1, wherein the digital image comprises a digital mammography image, and wherein determining coordinates of an area of the digital image comprises determining coordinates of an area of the digital image defining a smallest rectangle that contains the largest connected component.

8. A method comprising:
receiving a digital image; and
detecting a region of interest of the digital image, detecting a region of interest including:
thresholding the digital image to create a corresponding binary image, the binary image comprising a plurality of pixels each of which is one of only two possible colors, the two possible colors being a first color and a second color;
identifying one or more connected components in the binary image, each connected component comprising a set of pixels of the first color such that any two pixels in the set are joined by a continuous path of pixels of the first color;
identifying a largest connected component from the identified one or more connected components; and
determining coordinates of an area of the digital image defining a smallest predetermined shape that contains the largest connected component, the respective area of the digital image being designated as a region of interest of the digital image,
wherein receiving a digital image and detecting a region of interest are performed by a processor configured to receive a digital image and detect a region of interest.

9. The method of claim 8 further comprising:
determining or receiving one or more parameters based on one or more attributes of the digital image, including selecting a method for determining a threshold from a plurality of different methods for determining a threshold,
wherein thresholding the digital image comprises determining a threshold according to the selected method for determining a threshold, and thresholding the digital image based on the determined threshold.

10. The method of claim 9, wherein the selected method for determining a threshold is variable based on one or more attributes of the digital image.

11. The method of claim 8, wherein detecting a region of interest further comprises:
shrinking the digital image,
wherein thresholding the digital image comprising thresholding the shrunken digital image, and
wherein determining coordinates of an area of the digital image comprises determining coordinates of an area of the shrunken digital image, and determining corresponding coordinates of the digital image from the coordinates of the area of the shrunken image and dimensions of the digital image.

12. The method of claim 11 further comprising:
determining or receiving one or more parameters including a shrinkage factor representing an amount of shrinkage of the image,
wherein shrinking the digital image comprises shrinking the digital image based on the shrinkage factor.

13. The method of claim 8 further comprising:
determining or receiving one or more parameters including a selected level of connectedness,
wherein identifying one or more connected components comprises identifying one or more connected components according to the selected level of connectedness.

14. The method of claim 8, wherein the digital image comprises a digital mammography image, and wherein determining coordinates of an area of the digital image comprises determining coordinates of an area of the digital image defining a smallest rectangle that contains the largest connected component.

15. A computer program product comprising a computer-readable storage medium having computer-readable program code portions stored therein that in response to execution by a processor, cause an apparatus to at least perform the following:
receiving a digital image; and
detecting a region of interest of the digital image, detecting a region of interest including:
thresholding the digital image to create a corresponding binary image, the binary image comprising a plurality of pixels each of which is one of only two possible colors, the two possible colors being a first color and a second color;
identifying one or more connected components in the binary image, each connected component comprising a set of pixels of the first color such that any two pixels in the set are joined by a continuous path of pixels of the first color;
identifying a largest connected component from the identified one or more connected components; and
determining coordinates of an area of the digital image defining a smallest predetermined shape that contains the largest connected component, the respective area of the digital image being designated as a region of interest of the digital image.

16. The computer program product of claim 15, wherein the computer-readable storage medium has computer-readable program code portions stored therein that in response to execution by the processor cause the apparatus to further perform the following:
determining or receiving one or more parameters based on one or more attributes of the digital image, including selecting a method for determining a threshold from a plurality of different methods for determining a threshold,
wherein thresholding the digital image comprises determining a threshold according to the selected method for determining a threshold, and thresholding the digital image based on the determined threshold.

17. The computer program product of claim 16, wherein the selected method for determining a threshold is variable based on one or more attributes of the digital image.

18. The computer program product of claim 15, wherein detecting a region of interest further comprises:
shrinking the digital image,
wherein thresholding the digital image comprising thresholding the shrunken digital image, and
wherein determining coordinates of an area of the digital image comprises determining coordinates of an area of the shrunken digital image, and determining corresponding coordinates of the digital image from the coordinates of the area of the shrunken image and dimensions of the digital image.

19. The computer program product of claim 18, wherein the computer-readable storage medium has computer-readable program code portions stored therein that in response to execution by the processor cause the apparatus to further perform the following:
determining or receiving one or more parameters including a shrinkage factor representing an amount of shrinkage of the image,
wherein shrinking the digital image comprises shrinking the digital image based on the shrinkage factor.

20. The computer program product of claim 15, wherein the computer-readable storage medium has computer-readable program code portions stored therein that in response to execution by the processor cause the apparatus to further perform the following:
determining or receiving one or more parameters including a selected level of connectedness,
wherein identifying one or more connected components comprises identifying one or more connected components according to the selected level of connectedness.

21. The computer program product of claim 15, wherein the digital image comprises a digital mammography image, and wherein determining coordinates of an area of the digital image comprises determining coordinates of an area of the digital image defining a smallest rectangle that contains the largest connected component.
